(19) United States
(12) Patent Application Publication
(10) Pub. No.: US 2003/0231949 A1
(43) Pub. Date: Dec. 18, 2003

(54) Method for the ordering and grouping of flat products

(76) Inventors: Yannick Ribau, Les Sorinieres (FR); Jean-Marie Chenu, Nantes (FR)

Correspondence Address: James V. Costigan, Esq., Hedman & Costigan, P.C., Suite 2003, 1185 Avenue of the Americas, New York, NY, 10036-2601, US

(21) Appl. No.: 10/394,437

(22) Filed: Mar. 21, 2003

(30) Foreign Application Priority Data
Mar. 22, 2002 (IT) MI2002A 000604

(51) Int. Cl. B65G 57/00

(52) U.S. Cl. 414/798.8; 198/418; 414/798.2

(57) ABSTRACT

A method for the ordering and grouping of flat products comprising the following phases: feeding flat products (10) from a feeder (1) comprising a series (N) of parallel rows (11); placing each single subsequent line (R1, R2, R3, . . . , Rn) of flat products (10) inside a stacking device (2) comprising separation guides (3) for the flat products (10) and containers (4) arranged in series, moving in a transversal direction with respect to said parallel rows (11), suitable for housing said flat products (10) in groups (12) consisting of a number (M) of products (10), the value of (M) being equal to or lower than the value of (N); advancing the series of containers (4) by a step, step referring to the distance necessary for bringing a container (4) facing a row (11), in front of the adjacent row (11), programming said placement phase b) in relation to a pre-determined number of products to be grouped independently of the step-by step advancement phase c) of said series of containers; repeating the previous phases until a group (12) having a predefined number (M) of grouped flat products (10) is obtained inside at least one container (4).

The present invention relates to a method for the ordering and grouping of flat products.

In particular, the invention relates to a method for the ordering and grouping of flat products coming from a multiple-row feeder and destined for being packaged in groups.

The term “groups” and “grouping” indicates both the formation of vertical stacks of products and the formation of groups of products arranged edgeways.

The method according to the invention is particularly suitable for the ordering and grouping of large quantities of flat oven products coming from automatic production plants, but can relate to the ordering and grouping of any type of flat product to be packaged in groups and/or stacks.

With reference to flat oven products, production plants or lines are known, which comprise a production oven, conveying equipment and wrapping and packaging equipment.

In large productions plants, the phases for conveying the products are generally effected by means of multiple-row lines which allow a high number of products to be treated simultaneously.

If the products destined for group packaging are moved singly in each row, they must be subjected to an ordering and grouping phase which transfers them from a multiple-row arrangement to a group arrangement to be subsequently sent to the packaging machine.

In a traditional plant, for example, the products are dropped from a multiple-row feeder into transversally moveable containers and grouped, by means of subsequent feeding and step-by step advance phases of the containers.

After the dropping of the products, the containers are moved until they are in correspondence with a subsequent feeding line of the feeder to receive the following line of products, which are added to the previous ones, in the stacks being formed, until the pre-selected number of stacked products is reached.

A disadvantage of grouping plants of this type lies in the poor productive flexibility, particularly in the ordering and grouping phases of products arranged in multiple rows.

In plants of the type described above, groups consisting of N products are generally obtained from a number N of parallel rows.

In recent plants, the number of groups of products to be packaged has been doubled by means of selectors which allow an alternating arrangement in two groups for each feeding line present.

These plants, however, also have a poor flexibility as they are structured so as to only allow a double number of groups with respect to the number of rows of the feeder.

No proposals have as yet been made, however, for more flexible product distribution systems, i.e. whereby the number of feeding rows are not limited by the number of groups formed, allowing a number M of groups of flat products to be obtained from a number N of parallel rows, the definition of M generally being lower than N, depending on the production requirements.

Another disadvantage of the above plants according to the known art is linked to the fact that, in order to be able to differentiate the number of products grouped in a group, stoppages must be effected in the feeding plant or conveying plant of the containers in order to allow an advancement, in the former case, without increasing the number of grouped products and, in the latter case, a greater number of products grouped within the same container.

It is evident how the total amount of stoppage times of the plant reduces the plant productivity and causes a rise in costs.

A first objective of the present invention is consequently to overcome the above drawbacks by providing a method for the ordering and grouping of flat products which allows complete flexibility in defining both the number of groups to be obtained and also the number of products to be grouped.

Another objective of the present invention is to provide a method which, due to a rationalized functioning of the plant, allows the stoppages to be minimized, with a consequent increase in the productivity.

The objectives of the present invention also include a method which can be applied to existing plants for improving their flexibility and productivity.

These objectives are achieved by means of a method for the ordering and grouping of flat products according to what is described in the enclosed claims.

The method for the ordering and grouping of flat products comprises the following phases: feeding flat products (10) from a feeder (1) comprising a series (N) of parallel rows (11); placing each single subsequent line (R1, R2, R3, . . . , Rn) of flat products (10) inside a stacking device (2) comprising separation guides (3) for the flat products (10) and containers (4) arranged in series, moving in a transversal direction with respect to said parallel rows (11), suitable for housing said flat products (10) in groups (12) consisting of a number (M) of products (10), the value of (M) being equal to or lower than the value of (N); advancing the series of containers (4) by a step, step referring to the distance necessary for bringing a container (4) facing a row (11), in front of the adjacent row (11), programming said placing phase b) in relation to a pre-determined number of products to be grouped independently of the step-by-step advancement phase c) of said series of containers; repeating the previous phases until a group (12) having a predefined number (M) of grouped flat products (10) is obtained inside at least one container (4).

The characteristics and advantages of the method for the ordering and grouping of flat products according to the present invention will appear more evident from the following illustrative but non-limiting description, referring to the enclosed schematic drawings in which:

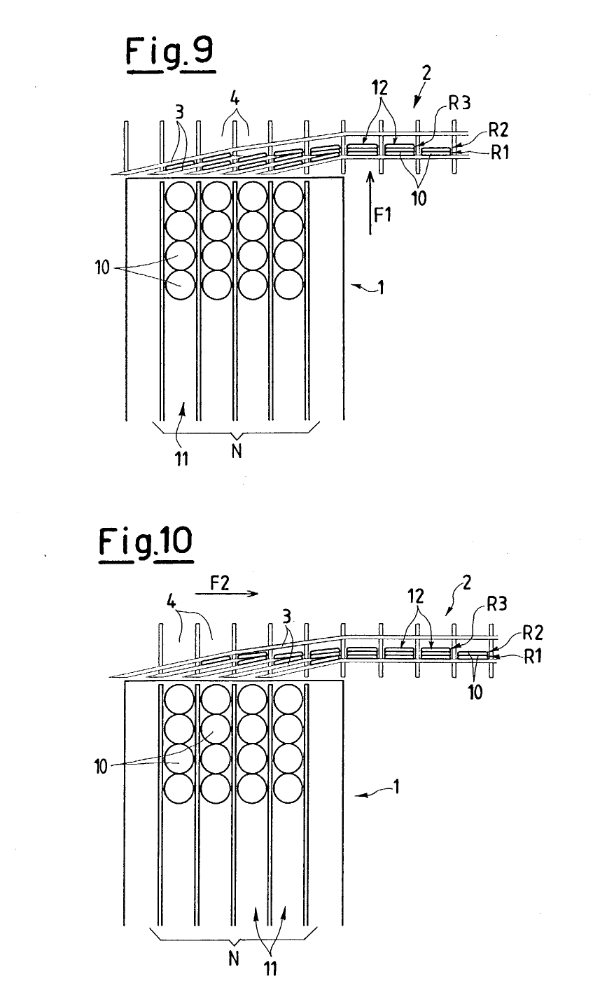

FIGS. 1 to 12 illustrate, in a schematic plan, a portion of the plant in the operating phases of the method according to the invention.

With reference to the Figures, for the sake of simplicity, these illustrate a feeder 1 of flat products 10 comprising four parallel feeding rows 11.

According to the embodiment selected, the plant is programmed to produce stacks 12 consisting of three flat products 10; the method however is generally applied to a feeder 1 comprising a number N of parallel rows and destined for obtaining stacks of M flat products 10, wherein the value of M is lower than the value of N. The stacks 12, as already mentioned, can be groups of products arranged edgeways.

The feeder 1 illustrated, is part of packaging equipment of flat products 10 which can operate alone or in connection with other production plant equipment.

The method, object of the invention, can obviously be applied to any kind of feeder of flat products 10.

The feeder 1 is designed for the continuous dropping, by means of known devices not illustrated and in the direction indicated by the arrow F1, lines R1, R2, R3, R4, . . . , Rn of flat products 10, for example oven products such as biscuits or other flat food products, inside a stacking device 2 (grouper) comprising separation guides 3 and moveable containers 4.

The containers 4 are moved in series by means of a conveyor which moves them in a transversal direction F2 with respect to the advancement direction of the lines of flat products 10 in the feeder 1.

The method according to the invention is illustrated in an application to a plant designed for the packaging of horizontal groups 12, and consequently the flat products 10 are placed edgeways in the containers 4.

The method can also be applied to feeders programmed for different arrangements of the flat products.

The method for the ordering and grouping of flat products comprises the following phases:

a) feeding the flat products 10 from the feeder 1 comprising a series N of parallel rows 11;

b) placing a line R1, R2, R3, . . . , Rn of flat products 10 inside a stacking device 2 comprising separation guides 3 for the flat products 10 and the containers 4 arranged in series, said containers 4 being moveable in a transversal direction with respect to said parallel rows 11 and suitable for housing said flat products 10 in groups 12 consisting of a number M of flat products 10, the value of M being equal to or lower than the value of N;

c) advancing a series of containers 4 by a step, a step referring to the distance necessary for bringing a container 4 facing a row 11, in front of the adjacent row 11;

d) repeating phases a), b), c) until a group 12 having a predefined number M of grouped flat products 10 is obtained inside at least one container 4;

e) advancing the series of containers 4 by the number of steps necessary for bringing the last container 4 which houses the predefined number M of flat products 10, outside the rows 11 of the feeder 1.

The number of advancement steps of the series of containers 4 can be reprogrammed each time if necessary to obtain a different number M of flat products 10 to be stacked inside each container 4.

The programming is specifically effected in relation to the number M of products 10 to be grouped and the number N of parallel rows 11 of the feeder 1.

In this respect, the plant is suitably equipped with a micro-processor through which the number of flat products to be grouped in each packaging and the number of packagings to be obtained, are programmed and which consequently drives the operation of the method phases.

The sequence of phases illustrated in the figures allows the plant functioning to be followed according to the method, object of the present invention.

With reference to FIG. 1, the first line R1 of flat products 10 has been placed inside four different containers 4, each flat product 10 being inserted inside one of the containers 4 according to phases a) and b) of the method.

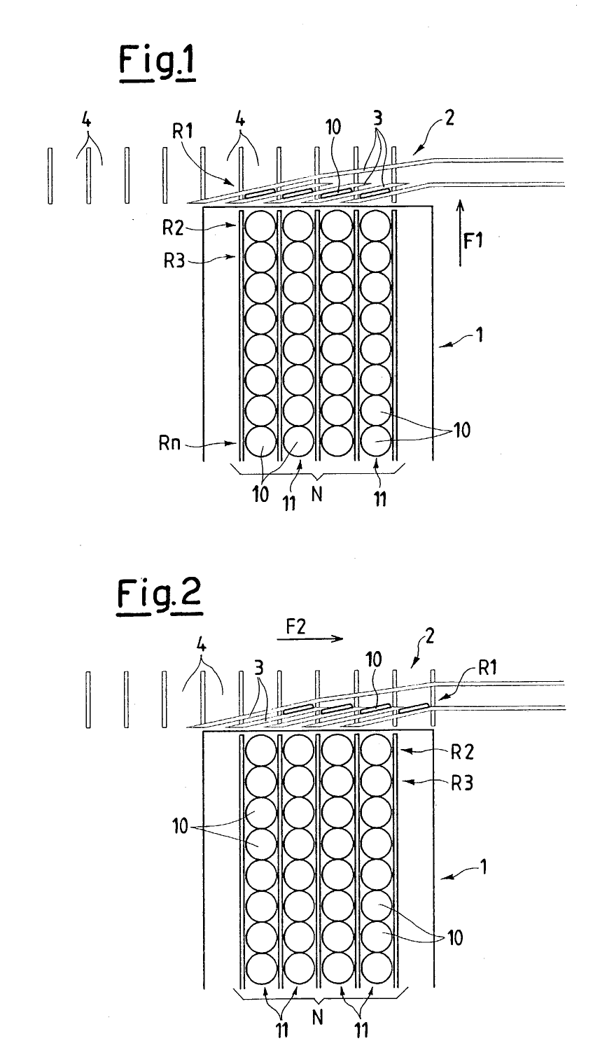

In FIG. 2, the series of containers has been advanced by a step, according to phase c) of the method.

It can be observed that, if packagings of single flat products are desired, after the first execution of phases a), b) c), phase d) is also effected, and a subsequent phase would consist in advancing the four containers, each containing one of the flat products 10, until they are brought outside the feeding rows.

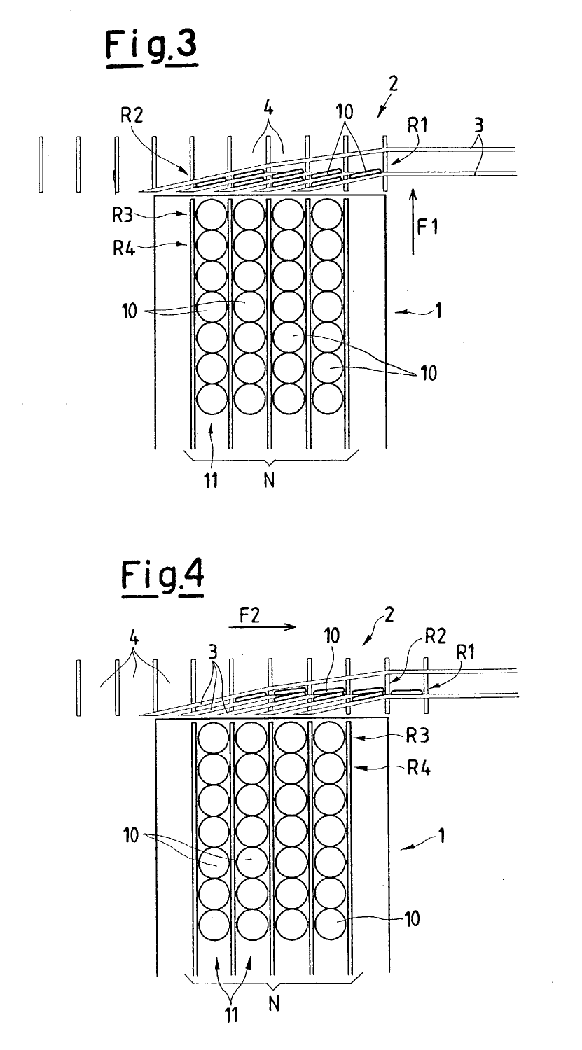

In the embodiment selected, packagings, and therefore groups or stacks 12, have been programmed, containing three flat products and consequently, as illustrated in FIGS. 3 and 4, the second line R2 of flat products 10 is placed inside the containers 4 and the series of containers is moved by a step, according to phase d).

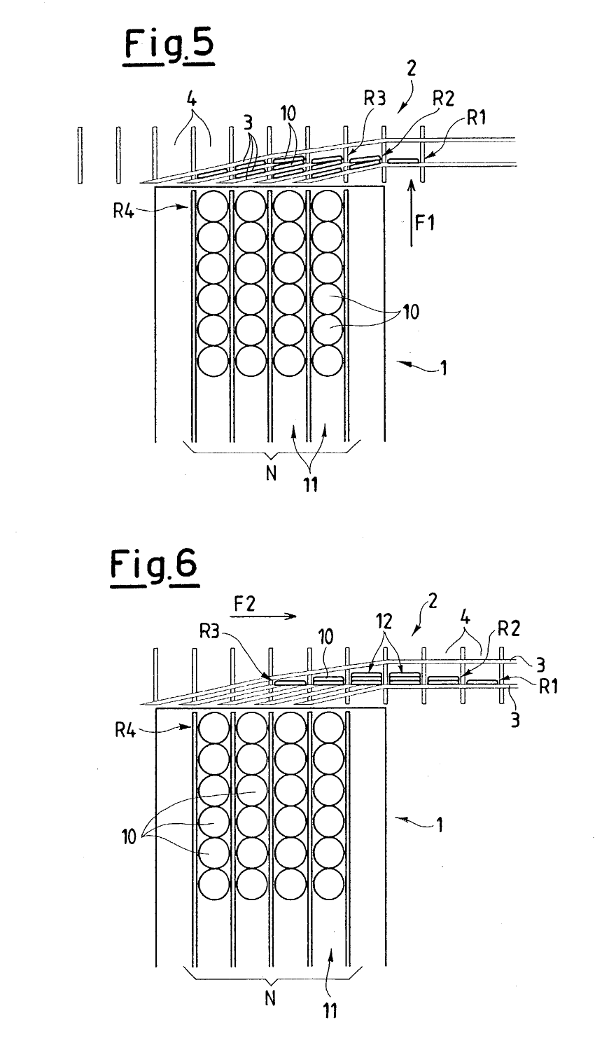

FIG. 5 illustrates the placing of a third line R3 of flat products 10.

As can be seen in FIG. 5, by means of this phase b), the pre-defined number M, in this case equal to three stacked or grouped flat products 10, is reached in two containers 4, and consequently the subsequent phase is that illustrated in FIG. 6.

This phase consists in advancing the containers 4 by two steps in order to bring the two containers of the series, which have reached the defined number M of flat products 10, outside the feeding rows, and at the same time move a container 4, containing two flat products 10 i.e. M−1 products, close to the last feeding row.

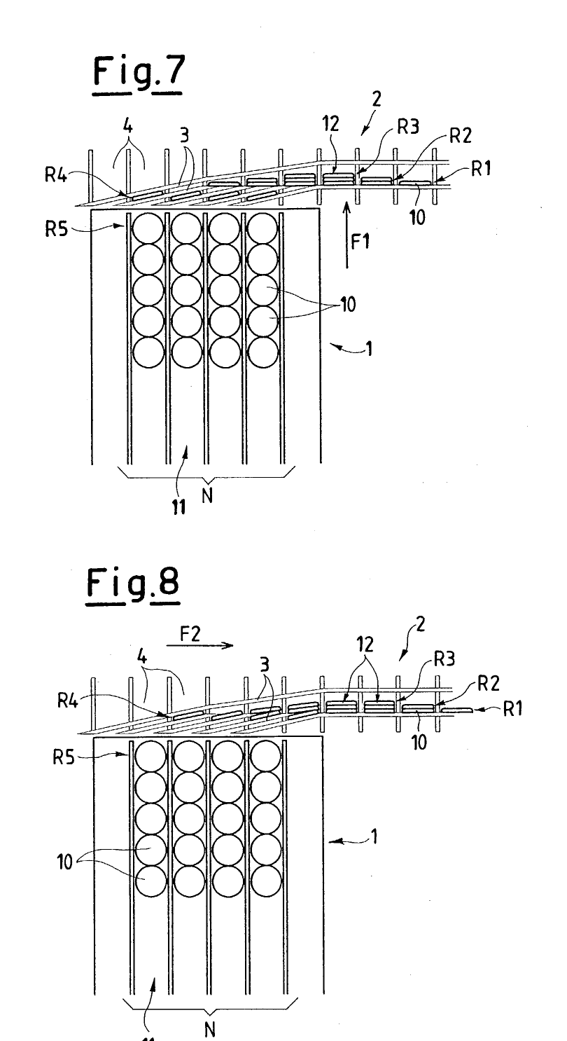

This container is subsequently filled in the following placement illustrated in FIG. 7.

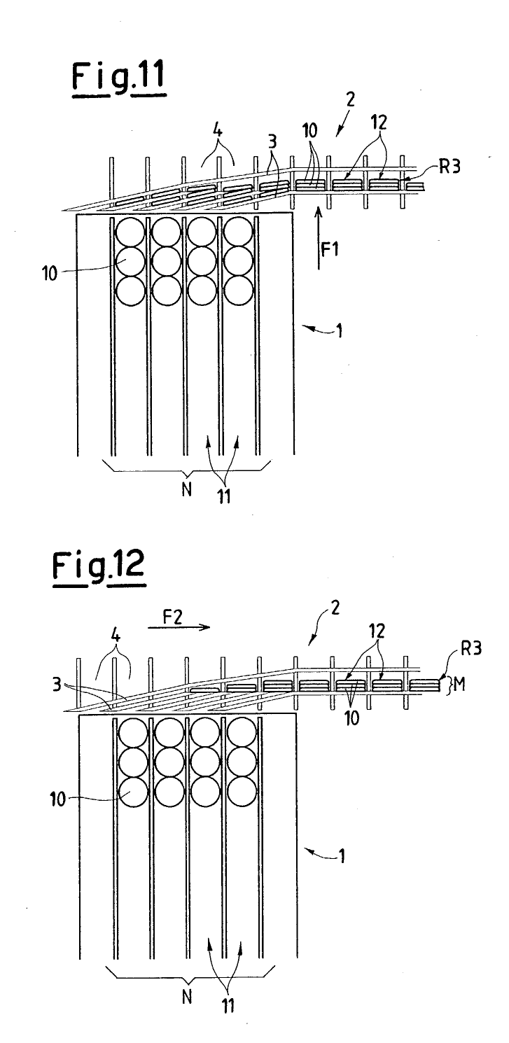

FIGS. 7 to 10 illustrate the repetition of the final phases effected with the moving by a step of the containers, whereas FIGS. 11 and 12 show, similarly to FIGS. 5 and 6, the formation of the predefined number M of flat products inside two of the containers 4 and the consequent moving of the series of containers, by two steps.

The method according to the invention allows the number of groups or stacks 12 to be formed and also the number M of products to be inserted in each group or stack, to be programmed at any moment, without necessarily having to stop the plant.

The method according to the invention can also be applied to existing plants to rationalize their production.

The method according to the invention advantageously allows any form of flat product to be treated, and also flat products previously packaged singly, to be grouped or stacked for subsequently packaging in stacks.

1. A method for the ordering and grouping of flat products comprising the following phases:
a) feeding flat products (10) from a feeder (1) comprising a series (N) of parallel rows (11);
b) placing each single subsequent line (R1, R2, R3, . . . , Rn) of flat products (10) inside a stacking device (2) comprising separation guides (3) for the flat products (10) and containers (4) arranged in series, moving in a transversal direction with respect to said parallel rows (11), suitable for housing said flat products (10) in groups (12) consisting of a number (M) of products (10), the value of (M) being equal to or lower than the value of (N);
c) advancing the series of containers (4) by a step, step referring to the distance necessary for bringing a container (4) facing a row (11), in front of the adjacent row (11),
d) programming said placing phase b) in relation to a pre-determined number of products to be grouped independently of the step-by-step advancement phase c) of said series of containers;
e) repeating the previous phases until a group (12) having a predefined number (M) of grouped flat products (10) is obtained inside at least one container (4).

2. The method according to claim 1, characterized in that the number of lines of products entering the containers (4) can be programmed in relation to the number (M) of flat products (10) to be grouped inside each container (4) and the number (N) of parallel rows (11) of the feeder (1).

3. The method according to claim 2, wherein the number of placements of each single line (R1, R2, R3, . . . , Rn) of flat products (10) can be programmed by means of a micro-processor.
